(19) United States
(12) Patent Application Publication
(10) Pub. No.: US 2015/0040838 A1
(43) Pub. Date: Feb. 12, 2015

(54) Pest Bird Deterrent Device

(71) Applicant: Beverly Hissom, Cincinnati, OH (US)

(72) Inventor: Beverly Hissom, Cincinnati, OH (US)

(21) Appl. No.: 14/297,884

(22) Filed: Jun. 6, 2014

Related U.S. Application Data
(60) Provisional application No. 61/863,669, filed on Aug. 8, 2013.

(51) Int. Cl. A01M 29/32

(52) U.S. Cl. CPC A01M 29/32
USPC 119/713

(57) ABSTRACT

Disclosed is a bird deterrent device to prevent pest birds from landing and nesting in various outdoor areas. The bird deterrent device of the present invention includes an elongated stem with a pointed lower end that is adapted to be inserted into various penetrable surfaces such as soil or ground. The stem further includes a plurality of spike members disposed near the top end thereof, wherein the spike members branch outward from various locations around the elongated stem and extend outward therefrom at various angles. The spike members may also overlap one another to prevent birds from roosting on the bird deterrent device. When the device is positioned, the spike members span out in a fan-like arrangement to eliminate open areas within its immediate perimeter. In this way, the present invention prevents birds from landing and resting in specific areas without harming the pest birds.

### CROSS REFERENCE TO RELATED APPLICATION

This application claims the benefit of U.S. Provisional Application No. 61/863,669 filed on Aug. 8, 2013. The above identified patent application is herein incorporated by reference in its entirety to provide continuity of disclosure.

### BACKGROUND OF THE INVENTION

1. Field of the Invention

The present invention relates to a bird deterrent device. More specifically, the present invention pertains to an improved bird deterrent device that provides bird control coverage over various outdoor areas, wherein the location of the spike elements are improved over existing bird deterrent devices. The bird deterrent device of the present invention includes an elongated stem and a plurality of spike elements that branch outward therefrom. The present invention is adapted for use in gardens and planters, and provide humane and effective means to eliminate or deter pest birds from resting and nesting in areas where they are not wanted.

Pest birds can be problematic in many human-inhabited areas, including urban areas, residential areas, rural communities, and farms. For instance, incessant bird chirping can also cause annoyance, especially in residential areas. In another instance, bird droppings can cause damage to equipment, properties, and buildings, particularly buildings constructed of limestone or calciferous sandstone. The acids and organisms contained in bird droppings can cause irreversible damage to the fabric of the building, causing scarring and damaging the appearance. The corrosive effects can also continue over time, even after the droppings have been removed. Beyond the obvious nuisance and unsightly droppings, pest birds can create health-related problems through their feces, including histoplasmosis, cryptococcosis, and psittacosis. Accordingly, pest bird control is needed to eliminate or deter pest birds from landing, roosting, and nesting in human-inhabited areas.

Methods of bird control include physical deterrents, visual deterrents, and sonic devices, among others. Physical bird deterrents include such products as steel or plastic spike systems, bird netting, slope barriers. While the most effective bird control product option is bird netting, this is not always a viable option. Additionally, steel or plastic spike systems comprise sharp spikes that can pierce and impale birds, as well as people that come in contact with the spikes.

Other bird deterrents incorporate a variety of different bird scare stimuli such as distress calls and electronic sounds in a random pattern so the birds cannot become accustomed. These deterrents may incorporate visual bird scarers such as scare crows. When the audio and visual products are used in combination so that the audio product emits sounds in a random pattern and the visual product is moved around a specific area, pest birds perceive a more realistic threat to their safety. However, placing several different visual bird scare products about the area and combining with an audio bird deterrent to send pest birds can be impractical and inconvenient to the user.

The present invention provides a bird deterrent device comprising a rigid, elongated stem that includes a pointed end that is adapted to be inserted into the ground or soil. In this way, the device is preferably used in areas around the garden or in planters, such as hanging baskets and pots. The stem further includes a plurality of spikes that branch outward and upward in a random pattern so that the spikes extend above the potted plants. The present invention may be used or alone or in multiples to cover a wider area.

### DRESCRIPTION OF THE PRIOR ART

Devices have been disclosed in the prior art that prevent birds from landing, roosting, and nesting. These include devices that have been patented and published in patent application publications, and generally relate to bird deterrent or bird control devices. Some of these devices disclose an elongated base with a series of spikes in a linear configuration that extend upwards to deter birds from landing on a building or a structure. Other devices disclose a combination of a bird detecting sensor and a noise generator that recognizes the approach of the birds and generates noises and sound waves which the birds dislike. These devices, however, do not disclose an elongated stem that includes a plurality of spikes in a varying configuration therearound, and wherein the stem is adapted to pierce into a surface. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 3,282,000 to Shaw discloses a bird proofing device comprising an elongated base support having a flat bottom surface and partially sloped side walls extending upwardly from the bottom surface and a top wall joining the side walls and spaced from the bottom surface. The Shaw device is adapted to be placed on buildings in which it does not detract from the appearance of a building or other structure on which it is used. Accordingly, the Shaw device is constructed for use on buildings and structures having flat ledges or surfaces.

Similarly, U.S. Pat. No. 6,250,023 to Donoho discloses a bird proofing assembly comprising a base and a plurality of spikes attached thereon. The base is provided with canals and each spike has a knurled end. The spikes are force fitted into the canals so as to be held firmly therein an upright position. While the bird proofing assembly of Donoho prevents the birds from resting and nesting around the areas in which the assembly is placed, the purpose and design of the Donoho assembly differ from the present invention. The present invention provides a stem that is adapted to stick into the ground or soil where bird nesting is not desired. Additionally, the stem includes a plurality of spikes that extend upwards and outwards therefrom.

U.S. Pat. No. 6,718,701 to Riddell discloses a bird deterrent device comprising an elongated base having spike elements extending thereabove. The base comprises alternating segments of differing widths having a scored or reduced thickness portion therebetween, and an elevated portion through which the spike elements are inserted into a channel formed in the bottom side of the base, the channel further having detents designed and constructed to hold the spike elements in place upon insertion.

The foregoing Shaw, Donoho, and Riddell devices are directed toward bird deterrent devices with spike elements that are disposed in a linear formation along an elongated base with a flat bottom surface. The flat bottom surface of the elongated base limits the placement of the bird deterrent devices to flat surfaces. The present invention provides an elongated stem that includes a pointed tip that is adapted to stick into the ground or soil so that the device is secured in an upright position. As such, a flat surface is not required to install the present invention.

Additionally, the linear formation of the spike elements in Shaw, Donoho, and Riddell do not provide a 360 degree coverage around the area where birds are not desired. In contrast, the present invention provides an elongated stem with protruding spikes that are spaced in an overlapping configuration along the length of the stem. The overlapping configuration of the spikes establish a high density 360 degree coverage that prevents the pest birds from resting in the area where the birds are not desired.

U.S. Pat. No. 7,040,058 to Finkelstein discloses an anti-bird roosting device for protecting an area, comprising at least a pair of base elements mounted on the area to be protected, and a plurality of projecting spikes, supported on the base elements and projecting away therefrom into a space above the area to be protected. Unlike the present invention, however, the spikes are provided in a pattern of interspersed combinations of vertical, obtuse, and acute angle-forming projections, in a high spike density that prevents roosting in the protected space. The present invention provides a plurality of spikes that are positioned in a random pattern around the stem. In this way, the device offers an angle coverage of 360 degrees around the area being protected from pest birds.

U.S. Published Patent Application No. 2013/0014692 to Lee provides a bird repeller adapted to prevent birds from approaching a utility pole and nesting thereon. The bird repeller apparatus utilizes a solar panel, which powers a bird detecting sensor that recognizes approach of the birds to trigger noise and sound wave generators. The noise and sound wave generators emit noise and sound waves which the birds dislike. Additionally, the apparatus includes an LED light emitter to emit light which deter the birds. In this way, the apparatus inhibits the birds from nesting between the cross arms of a utility pole, which prevents the birds from damaging utility poles.

The device disclosed in Lee, however, is limited in the fact that it requires a power supply, such as a solar panel. Unlike the device disclosed in Lee application, the present invention is not limited to use with a power source because it utilizes the structural design of the device to discourage pest birds from resting on areas where they are not wanted. More specifically, the present invention includes several spikes that project outward at various angles that makes it difficult for birds to land. Without a power source, the device disclosed in Lee does not have structural means to deter birds from nesting between the cross arms of a utility pole.

Finally, U.S. Pat. No. 5,348,138 to Seemann discloses a bird gate for a grain auger that includes a panel that extends across the auger outlet in a closed position. The panel is held in a closed position via a spring that is engaged to the panel. The panel, however, opens when grain is delivered from the auger and applies force on the panel, allowing the grain to be delivered from the auger. When the grain is delivered, the panel returns to the closed position. In this way, the closed position of the panel prevents birds from entering the auger for nesting. While the panel of the Seemann device prevents birds from nesting within the auger, the purpose and design of the Seemann device differ from the present invention. The present invention is not designed to be manipulated between an open position and a closed position to enclose an area for preventing birds from nesting. Rather, the present invention is a static bird control device that protect a surrounding open area.

The devices disclosed in the prior art have several known drawbacks. These devices are limited for use with specific structures and do not provide a 360 degree coverage. The present invention overcomes these limitations by disclosing an elongated stem that sticks into any surface that may be pierced so that the device may be secured in an upright position. The elongated structure of the elongated stem also provide height to the device so that it may extend above tall plants and other objects in a specific area. Additionally, the present invention provides a plurality of spikes that project outward at different angles to establish an all-around coverage in the area where the device is placed. The placement of the spikes prevents the pest birds from landing or resting on the device or areas where the device is placed. It is therefore submitted that the present invention is substantially divergent in design elements from the prior art, and consequently it is clear that there is a need in the art for an improvement to existing bird deterrent devices. In this regard, the instant invention substantially fulfills these needs.

### SUMMARY OF THE INVENTION

In view of the foregoing disadvantages inherent in the known types of bird deterrent devices now present in the prior art, the present invention provides a new and improved bird deterrent device wherein the same can be utilized for preventing pest birds from landing and nesting in areas where they are not wanted.

It is therefore an object of the invention to provide a new and improved bird deterrent device that has all of the advantages of the prior art and none of the disadvantages.

Another object of the present invention is to provide a new and improved bird deterrent device that includes an elongated stem and a plurality of spikes protruding at various outward angles to prevent pest birds from landing and nesting in areas where they are not wanted.

Yet another object of the present invention is to provide a new and improved bird deterrent device that includes an elongated stem having a pointed tip adapted to be inserted into a surface to support a plurality of spikes disposed thereon in an elevated position above the surface.

Still yet another object of the present invention is to provide a new and improved bird deterrent device that includes a plurality of spikes that overlap one another in a varying configuration to provide an all-around protection of a specific area.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of a first embodiment of the present invention.

FIG. 2 shows a perspective view of another embodiment of the present invention.

FIG. 3 shows a view of the present invention in use with a hanging planter.

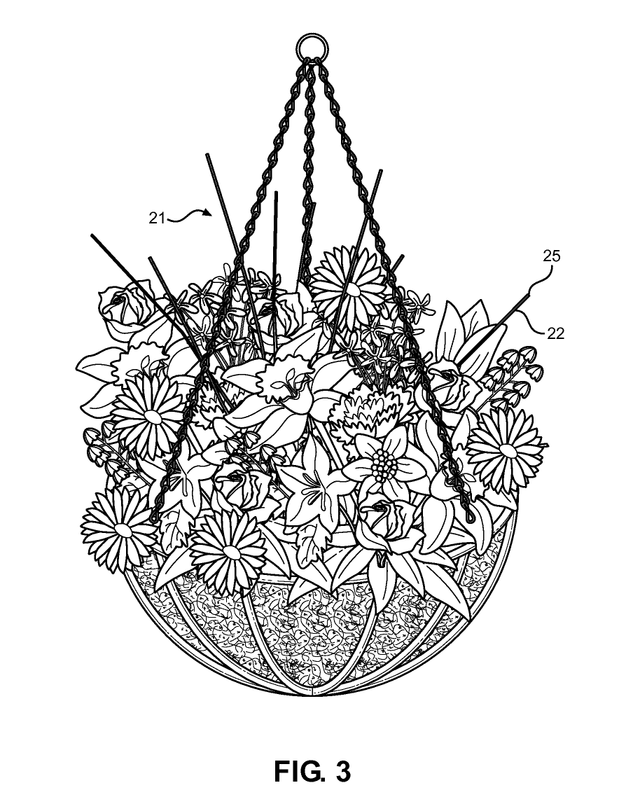

### DETAILED DESCRIPTION OF THE INVENTION

References are made herein to the attached drawings. Like reference numerals are used throughout the drawings to depict like or similar elements of the bird deterrent device. For the purposes of presenting a brief and clear description of the present invention, the preferred embodiment will be discussed as used for discouraging pest birds from landing and resting on areas where they are not wanted. The figures are intended for representative purposes only and should not be considered to be limiting in any respect.

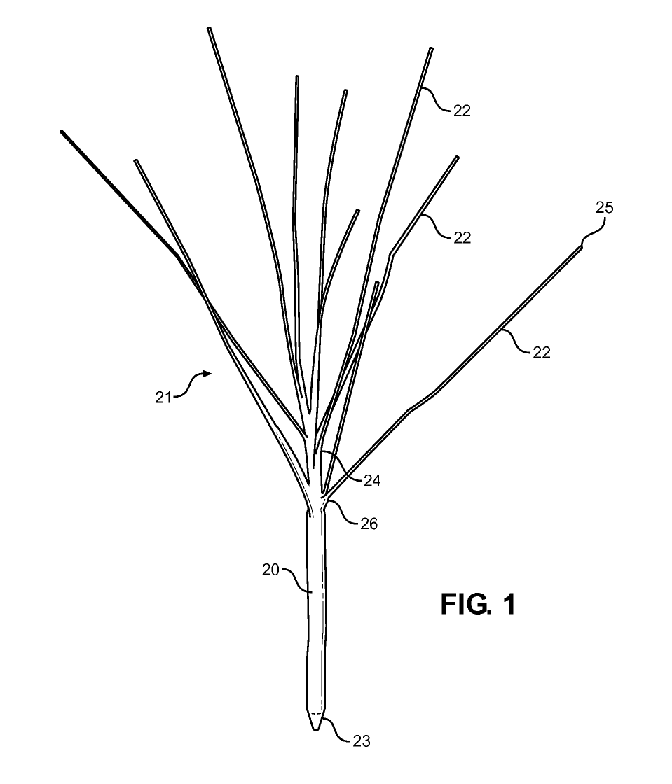

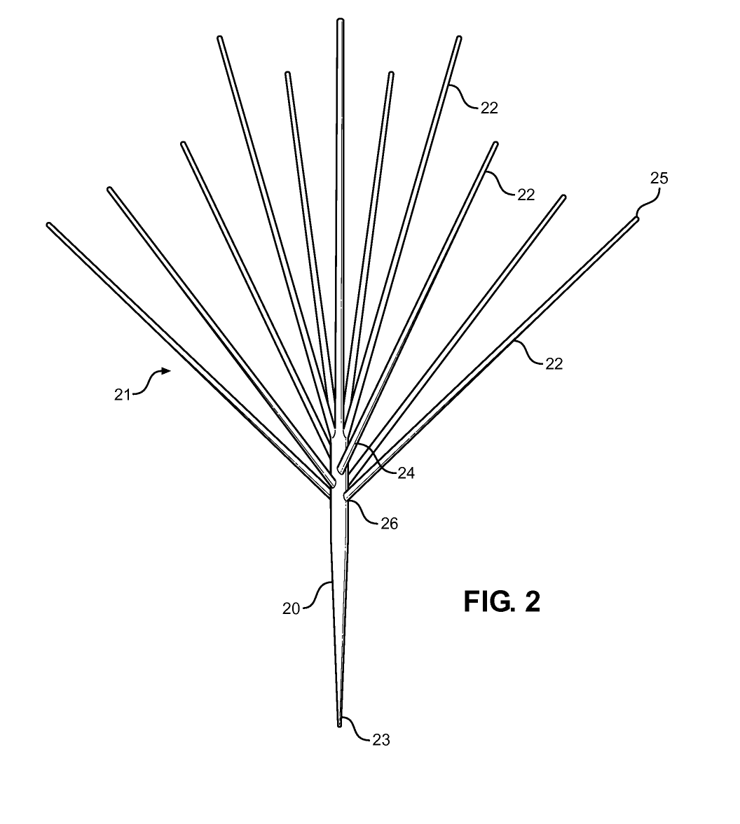

Referring now to FIGS. 1 and 2, there are shown perspective views of the various embodiments of the present invention. The bird deterrent device 21 comprises an elongated stem 20 having a length. In a preferred embodiment, the stem 20 may be a substantially circular shaft of a diameter that is generally uniform over its length. The stem 20 may comprise rigid material such as plastic, metal, or the like. The stem 20 includes a top end 24 and a lower end 23. The lower end 23 of the stem 20 is tapered or pointed so as to allow a user to insert the device 21 into the ground or other penetrable surfaces such as soil. In an alternate embodiment, the entire length of the stem 20 may be tapered so that the diameter of the lower end 23 is narrower than the diameter of the top end 24. In this way, the lower end 23 may be easily inserted into a penetrable surface such as soil, and the device 21 may be positioned in a substantially upright position or at an angle. Accordingly, the present invention is not limited for use on a flat surface, providing versatility to the user for use with uneven or sloped surfaces.

The stem 20 also comprises a plurality of elongated spikes 22 that branch outward at various angles therefrom. The spikes 22 comprise the same rigid material that forms the stem 20. The spikes 22 include an attachment end 26 and a terminal end 25. The attachment end 26 is attached to the stem 20 near the top end 24 of the stem 20. In a preferred embodiment, each of the spike 22 is a shaft having a circular cross section of a diameter that is substantially uniform over its length, wherein the diameter of the spike 22 is narrower than that of the stem 20. Alternatively, each of the spike 22 may be slightly tapered toward the terminal end 25 so that the diameter of the attachment end 26 is wider than the diameter of the terminal end 25. In either embodiments, however, each of the terminal end 25 is rounded to prevent impaling birds. In this way, the present invention provides humane and effective means to eliminate or deter pest birds from resting and nesting in areas where they are not wanted.

The spikes 22 may be attached to the stem 20 using various fastening means such as epoxy. Alternatively, the spikes 22 may be integrally formed as part of the stem 20. Each of the spikes 22 are oriented at varying directions so that the terminal ends 25 branch outwards from the centrally located stem 20. Additionally, each of the attachment end 26 is disposed at various locations on the stem 20. More specifically, the spikes 22 may be disposed on various locations around the circumference of the stem 20, as well as on various locations along the length of the stem 20. It is preferred, however, that the spikes 22 are located near the top end 24 of the stem 20. In this way, the spikes 22 provide a 360 degree coverage around the stem 20, in order to protect a specific area. Additionally, the spikes 22 overlap one another to reduce the amount of space between each of the spikes 22, thereby preventing pest birds from roosting and building a nest between the spikes 22. Each of the spikes 22 may be substantially equal in length and diameter. The spikes 22 are constructed to extend above the surface to be protected from pest birds, but may be trimmed to a specific length as desired by the user.

Referring now to FIG. 2, there is shown a view of the present invention in use with a hanging planter. The device 21 is lightweight so as to be suitable for hanging from an overhead support. The lower end of the stem may be inserted into the soil within the hanging planter without compromising the flower or plant arrangement. The stem may be inserted in an upright position or at an angle to suit the needs of the user. The device 21 may be used alone or in multiples to provide sufficient coverage over the desired area. When the device 21 is inserted, the spikes 22 span in a fan-like arrangement to eliminate all open areas existent within the surrounding area of the planter.

The device 21 blends in with the flower or plant arrangement so it does not detract from the aesthetic appearance of the planter and the flower or plant arrangement therein. The spikes 22 angle outward between the flower or plant arrangement and the terminal ends 25 of the spikes 22 extend upwards, thereby deterring birds from landing and resting on the flower or plant arrangement. In this way, the birds are unable to nest in the planter, which allow users to maintain the flower or plant arrangement without interfering with the birds or their nests therewithin.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A bird deterrent device, comprising:
an elongated stem having a top end and a lower end;
said elongated stem forming a vertical axis;
said lower end comprising a pointed tip adapted to be inserted into a surface;
a plurality of spikes having an attachment end and a terminal end; and
each of said plurality of spikes extending outward at a different angle relative to said elongated stem.

2. The bird deterrent device of claim 1, wherein said stem and said plurality of spikes comprise a rigid material.

3. The bird deterrent device of claim 1, wherein said elongated stem comprises a cylindrical shaft of a diameter that is generally uniform over a length of said elongated stem.

4. The bird deterrent device of claim 1, wherein said elongated stem tapers from said top end to said lower end.

5. The bird deterrent device of claim 1, wherein said lower end is rounded.

6. The bird deterrent device of claim 1, wherein said plurality of spikes comprise a cylindrical shaft of a diameter that is generally uniform over a length of each of said plurality of spikes.

7. The bird deterrent device of claim 1, wherein said plurality of spikes are integrally formed with said elongated stem.

8. The bird deterrent device of claim 1, wherein each of said plurality of spikes are substantially equal in length.

9. The bird deterrent device of claim 1, wherein each of said plurality of spikes comprise a variety of lengths.

10. The bird deterrent device of claim 1, wherein said plurality of plurality of spikes taper from said attachment end to said terminal end.

11. The bird deterrent device of claim 1, wherein said terminal end of each of said plurality of spikes is rounded.

12. The bird deterrent device of claim 1, wherein said plurality of spikes comprise one or more bends such that said plurality of spikes are not linear.

13. The bird deterrent device of claim 1, wherein said plurality of spikes are attached to said elongated stem at various locations along a circumference of said elongated stem.

14. The bird deterrent device of claim 1, wherein said plurality of spikes are attached to said elongated stem at various heights along said length of the elongated stem.
